(19) United States
(12) Patent Application Publication
(10) Pub. No.: US 2012/0323795 A1
(43) Pub. Date: Dec. 20, 2012

(54) ONLINE MARKETPLACE WITH DYNAMIC PRICING

(75) Inventor: Stelios Paparizos, San Jose, CA (US)

(73) Assignee: MICROSOFT CORPORATION, Redmond, WA (US)

(21) Appl. No.: 13/163,554

(22) Filed: Jun. 17, 2011

(51) Int. Cl. G06Q 30/00

(52) U.S. Cl. 705/80

(57) ABSTRACT

Systems and methods for dynamic pricing in real-time marketplace transactions are provided. A method may include receiving a request from a bid agent associated with a location-aware user device, and an offer for goods/services from an offer agent that is associated with a merchant device. The offer may include an inventory and one or more locations of the goods/services. The method includes determining a location of the location-aware user device, and determining whether the inventory and the one or more locations of the goods/services are sufficient to satisfy the request. If so, then the method includes establishing a real-time dynamic marketplace session between the offer agent and the bid agent to facilitate a negotiation for the goods/services. Upon receiving an acceptance from the offer agent for a bid from the bid agent, the method includes processing a purchase transaction for the goods/services.

### BACKGROUND

On-line shopping services typically facilitate purchasing transactions that enable individual customers to purchase goods and/or services from a merchant. Some on-line services, such as travel reservation websites, may search among multiple merchants for products and/or services that match a user's search criteria. Deal-of-the-day and other group buying websites may offer products or services at discounted prices for a limited period of time to users who subscribe to these services. Further, some advertisers offer local coupons to users of location aware devices that are detected to be within a target region. However, even when products and services are offered in bundles, offered to a subscriber group, and/or the subject of location-specific offers, as described above, many of these offers may be priced just beyond a potential buyer's willingness to pay. The offer price is typically fixed until the product is sold, or if the product is not sold within a given time period, the seller may adjust the price downward to encourage sales. However, such manual or algorithmic adjustment of price is based on whether or not the product was sold at the marketplace portal. The seller has no way to communicate with particular buyers, for example, to learn that a buyer may be willing to pay just a little less than the current asking price for a product, or travel a bit further to pick up a less expensive product. Lacking this knowledge, mispricing may result, and willing buyers and willing sellers may miss opportunities to consummate sales that would be of mutual benefit.

### SUMMARY

Systems and methods for dynamic pricing in real-time marketplace transactions are disclosed herein. One method may include receiving a request from a bid agent that is associated with a location-aware user device. The method includes receiving an initial offer for goods/services from an offer agent that is associated with a merchant device. The initial offer may comprise an inventory and one or more locations of the goods/services. The method includes determining a location of the location-aware user device, and determining whether the inventory and the one or more locations of the goods/services are sufficient to satisfy the request, based at least in part on the location of the location-aware user device.

If the inventory and the one or more locations of the goods/services are sufficient to satisfy the request from the bid agent, then the method includes sending the initial offer including an initial price to the bid agent, and receiving a bid for the initial offer from the bid agent. The method may then include revising the initial price of the initial offer to a revised price based on a change to the inventory and/or a change to a cost of providing the goods/services. The method includes sending a revised offer for the goods/services and a revised price to the bid agent, and receiving a revised bid from the bid agent. The method then includes sending the revised bid to the offer agent, receiving an acceptance from the offer agent, and processing a purchase transaction for the goods/services between the offer agent and the bid agent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a marketplace server for facilitating purchase transactions including dynamic pricing between one or more merchants associated with merchant devices and one or more users associated with location-aware user devices.

FIG. 2 is a detailed schematic view of the pricing engine shown in the marketplace server of FIG. 1.

FIG. 3 is a diagram illustrating a method for dynamic pricing in purchase transactions showing communications among a marketplace server, an offer agent and a bid agent.

FIG. 4 is a continuation of the diagram of FIG. 3.

FIG. 5 is a continuation of the diagram of FIG. 4.

### DETAILED DESCRIPTION

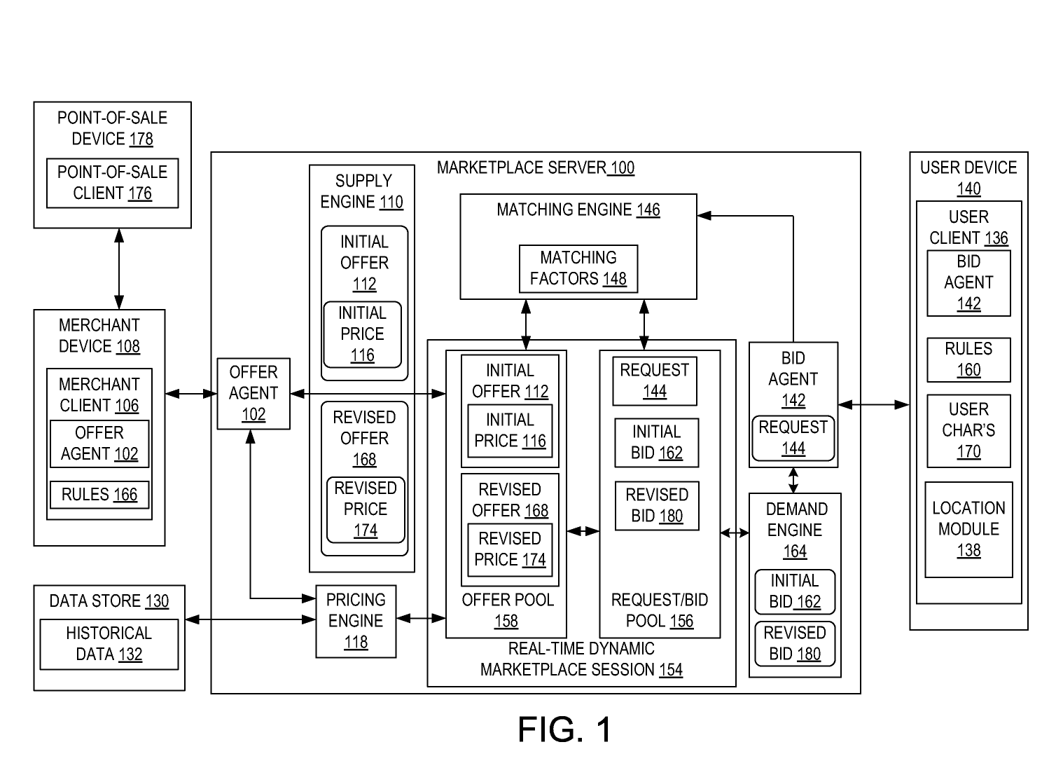

FIG. 1 is a schematic view of a marketplace server 100 for facilitating purchase transactions including dynamic pricing between a merchant associated with a merchant device 108 and a user associated with a location-aware user device 140. The merchant device 108 is associated with a merchant (not shown) that desires to sell goods and/or services to customers through the marketplace server 100. The location-aware user device 140 is associated with a user who desires to purchase goods and/or services through the marketplace server 100.

The merchant device 108 includes a merchant client 106 executed on the device that facilitates interactions between the merchant device and the marketplace server 100. The merchant device 108 is also associated with an offer agent 102. The offer agent 102 may function as a proxy for the merchant in conducting negotiations through the marketplace server 100. As shown in FIG. 1, the offer agent 102 may be located on the marketplace server 100 or on the merchant client 106. In the present example, it will be appreciated that one instantiation of the offer agent 102, either on the marketplace server 100 or on the merchant client 106, may be utilized. Additionally, while FIG. 1 shows a single merchant device 108 corresponding to a single merchant, in other examples additional merchants and corresponding merchant devices and offer agents may submit offers for goods and/or services and conduct negotiations through the marketplace server 100.

The offer agent 102 receives input from its corresponding merchant device 108 regarding the goods and/or services that the merchant desires to sell. Along with descriptions of the goods and/or services that the merchant desires to sell, such input may include, for example, an inventory and one or more locations of the goods and/or services. For example, the merchant may be a greengrocer that has 500 oranges to sell, with the oranges located at the greengrocer's fruit stand at 1000 Main Street in Seattle, Wash. As explained in more detail below, the description and other input regarding the goods and/or services may be used in presenting and revising offers for the goods and/or services. It will also be appreciated that other types of input regarding the goods and/or services may also be provided with offers.

In one example, the offer agent 102 may send an initial offer 112 to a supply engine 110. The initial offer 112 may include an initial price 116 that is received from the merchant client 106 via direct input from the merchant. In another example, the initial price 116 may be determined by the offer agent 102. In still another example, a pricing engine 118 may generate the initial price 116 for the initial offer 112. In generating the initial price 116, the pricing engine 118 may perform predictive price modeling based on information relevant to pricing, such as estimations of consumer demand for the goods/services of the relevant offer. In another example, the pricing engine 118 may access a data store 120 to retrieve historical transaction data 122 related to the goods/services of the relevant offer. The historical transaction data 122 may include data related to previous transactions for the same or similar goods/services. Such data may include, for example, recent prices paid by consumers for the same or similar goods/services. The pricing engine 118 may then use the historical transaction data 122 to generate an initial price 116 for the initial offer 112.

With continued reference to FIG. 1, as noted above the location-aware user device 140 is associated with a user (not shown) who desires to receive and bid on offers for goods and/or services through the marketplace server 100. The location-aware user device 140 includes a user client 136 executed on the device that facilitates interactions between the device and its associated user and the marketplace server 100. The user client 136 includes a location module 138 that is configured to determine a current location of the location-aware user device 140. The location module 138 may determine the location of the location-aware user device 140 by sensing one or more of GPS, Wi-Fi, and/or cell-tower radio signals, or other location-sensing modalities.

Each location-aware user device 140 is also associated with a bid agent 142. As described in more detail below, the bid agent 142 may function as a proxy for the user of the location-aware user device 140 in conducting negotiations through the marketplace server 100. Like the offer agent 102 described above, the bid agent 142 may be located on the marketplace server 100 or on the user client 136 of the location-aware user device 140. In the present example, it will be appreciated that one instantiation of the bid agent 142, either on the marketplace server 100 or on the user client 136, may be utilized, or components of the bid agent 142 may be included on both the marketplace server 100 and user client 136. Additionally, while FIG. 1 shows a single location-aware user device 140 corresponding to a single user, in other examples additional users and corresponding location-aware user devices and bid agents may submit bids for goods and/or services and conduct negotiations through the marketplace server 100.

The bid agent 142 receives input from its corresponding user regarding the types of offers for goods and/or services that the user desires to receive. Using this input, the bid agent 142 is configured to send an offer request 144 to a matching engine 146. The matching engine 146 is configured to match one or more offer requests, such as offer request 144, to one or more offers, such as the initial offer 112, received from the offer agent 102. In one example, the matching engine 146 is configured to match the initial offer 112 to the offer request 144 by matching one or more matching factors 148 received from offer agent 102 with one or more corresponding user characteristics 170 received from bid agent 142. The matching factors 148 and corresponding user characteristics 170 may include, for example, a type of the goods/services that were previously purchased by a user of the location-aware user device 140 associated with the bid agent 142, a loyalty measure reflecting a number of previous purchases made by the user from the merchant associated with the initial offer 112, prices paid for the type of goods/services previously purchased, and a location of the location-aware user device 140 when the goods/services were previously purchased by the user. Other examples of user characteristics 170 including user characteristics that indicate ancillary terms of purchase that the user values, such as warranty terms, shipping terms, service level terms, return policy terms, preferred purchase status terms, affinity reward point terms, item quality terms, or other non-price terms. These user characteristics may be directly input by the user for example in response to questioning by the user client 136, or may be inferred from user transaction history, browsing history, social graph data, etc. detected through user interaction with the user client 136 on the user device 140. It will be appreciated that other matching factors and corresponding user characteristics may also be used by the matching engine 146.

The matching engine 146 is also configured to determine a location of the location-aware user device 140 by receiving location information from the location module 138 of the user client 136. Upon matching the initial offer 112 to the offer request 144, the matching engine 146 is further configured to determine whether the inventory and the one or more locations of the goods and/or services associated with the initial offer 112 are sufficient to satisfy the offer request 144, based at least in part on the location of the location-aware user device 140. In one example, the initial offer 112 may be for 4 tickets to a previously sold-out circus performance beginning in 8 hours in downtown Seattle, Wash. The offer request 144 may be for 4 tickets to this particular circus performance. The user associated with the user device 140 that generates the offer request 144 resides in Seattle, Wash. However, the matching engine 146 determines that the user device 140 is currently located in Paris, France, indicating that the user is also likely in Paris. Given the distant location of the user with respect to the location of the circus performance that begins in 8 hours, the matching engine 146 may determine that the offer request 144 cannot be satisfied by the initial offer 112. In this case, the initial offer 112 is not sent to the bid agent 142 associated with the user device 140.

In another example, if the matching engine 146 determines that the user device 140 is currently located within a distance of downtown Seattle, Wash. that would enable the user of the user device 140 to attend the circus in 8 hours, then the matching engine may send the initial offer 112 to the bid agent 142. The bid agent 142 then may provide the initial offer 112 to the location-aware user device 140 via user client 136 for viewing and consideration by the corresponding user. It will also be appreciated that in other examples, the goods/services of the initial offer 112 may be located in multiple locations.

Upon viewing the initial offer 112 the user may elect to bid on the offer. In one example, the bid agent 142 may be configured to receive direct user input of an initial bid 162 on the initial offer 112 via the location-aware user device 140. In another example, the bid agent 142 may act as a proxy for the corresponding user and proceed with selecting and negotiating for initial offer 112 on behalf of the user. In this example, the bid agent 142 may be configured to programmatically elect to bid on the initial offer 112, and to generate a corresponding initial bid 162 for the offer. In this example, the bid agent 142 may utilize one or more rules 160 received from the associated user client 136 to elect to bid on the initial offer 112 and to generate the initial bid 162. The rules 160 may include, for example, user preferences for particular goods/services, bid pricing guidelines such as bid ceilings, etc. Once an initial bid 162 for the initial offer 112 has been created, the bid agent 142 may send the bid to a demand engine 164. In other examples, the demand engine 164 may be configured to receive additional bids from other bid agents for the initial offer or for different offers.

The matching engine 146 is further configured to establish a real-time dynamic marketplace session 154 between the offer agent 102 and the bid agent 142 in which a negotiation is facilitated between the merchant associated with offer agent 102 and the user associated with the bid agent 142. The real-time dynamic marketplace session 154 may include an offer pool 158 that receives one or more offers from the supply engine 110, and a request/bid pool 156 that receives one or more requests and bids from the demand engine 164. In one example, the offer pool 158 may pool two or more offers from multiple offer agents to form a pooled offer. Similarly, the request/bid pool 156 may pool two or more bids from multiple bid agents to form a pooled bid. For purposes of the following description, a negotiation between a single offer agent 102 and single bid agent 142 involving one initial offer 112 and corresponding initial bid 162 will be discussed.

In one example, the offer agent 102 may be configured to programmatically modify the initial offer 112 based on one or more rules 166 received from the merchant client 106 to create a revised offer 168. The rules 166 may include, for example, parameters for adjusting aspects of the initial offer 112 such as price, quantity, timing, etc. In another example, the offer agent 102 may be configured to programmatically modify the initial offer 112 based on one or more user characteristics 170 received from the user client 136. The user characteristics 170 may include, for example, a type of the goods/services that were previously purchased by the user associated with the bid agent 142, a loyalty measure reflecting a number of previous purchases made by the user from a merchant associated with the initial offer 112, a price paid for the type of goods/services previously purchased, and a location of the associated location-aware user device 140 when the goods/services were previously purchased by the user. It will be appreciated that other user characteristics may also considered and used by the offer agent 102.

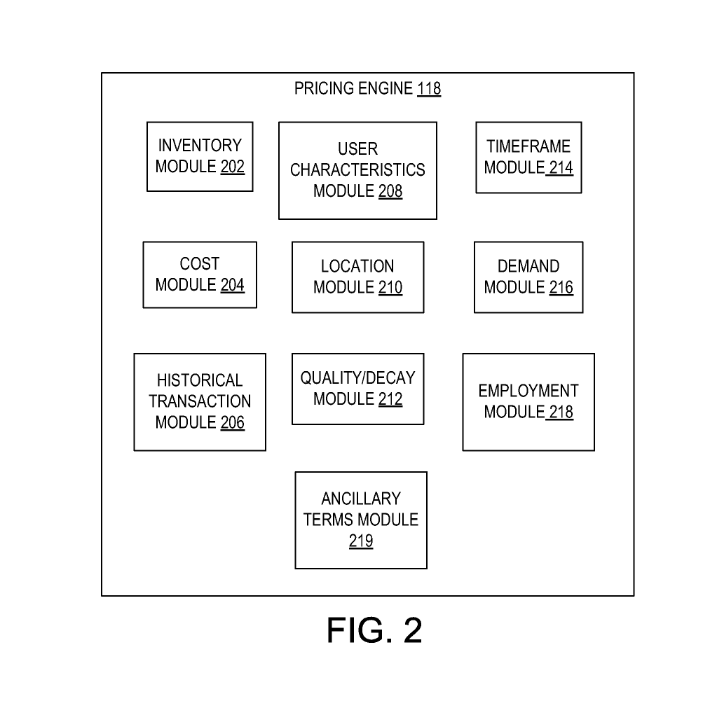

In another example, and with reference also to FIG. 2, the pricing engine 118 may include an inventory module 202 and a cost module 204 that are configured to programmatically revise the initial price 116 of the initial offer 112 to a revised price 174 based on a change to the inventory and/or a change to a cost of providing the goods/services, respectively. In one example, the inventory module 202 and the cost module 204 may be configured to receive information regarding a change to the inventory and/or a change to a cost of providing the goods/services from the offer agent 102.

The offer agent 102 may be configured to receive updated inventory and/or cost change information regarding the goods/services via the merchant client 106. The updated inventory information may be received by the offer agent 102 via direct input into the merchant device 108 from the merchant, or automatically from a point-of-sale client 176 located on a point-of-sale device 178. In one example, the point-of-sale device 178 may be a barcode scanner located at a checkout counter in a retail business. As customers purchase goods associated with the initial offer 112, the inventory of the goods is tracked and adjusted by the point-of-sale client 176 and sent to the merchant client 106 via the merchant device 108.

Information regarding a change to a cost of providing the goods/services may be determined by the offer agent 102. In one example, a greengrocer may receive notice that its supplier of oranges is immediately raising prices by 10%. The offer agent 102 may use this information to determine a change to the merchant's cost of selling the oranges. The inventory module 202 and the cost module 204 of the pricing engine 118 may be configured to use the updated inventory information and/or the change to the cost to programmatically revise the initial price 116 to a revised price 174 in a revised offer 168.

In another example, the pricing engine 118 may include a historical transaction module 206 that is configured to programmatically revise the initial price 116 of the initial offer 112 based on historical transaction data 132 related to the goods/services of the initial offer. As noted above, the pricing engine 118 may access the data store 130 to retrieve the historical transaction data 132. The historical transaction data 132 may include data related to previous transactions for the same or similar goods/services. Such data may include, for example, recent prices paid by consumers for the same or similar goods/services. The historical transaction module 206 of the pricing engine 118 may then use the historical transaction data 132 in performing predictive price modeling and generating a revised price 174 for the revised offer 168.

In another example, the pricing engine 118 may include a user characteristics module 208 that is configured to programmatically revise the initial price 116 of the initial offer 112 based on one or more user characteristics 170 received from the bid agent 142 via the user client 136. As noted above, the user characteristics may include, for example, a type of the goods/services that were previously purchased by a user of the location-aware user device 140 associated with the bid agent 142, a loyalty measure reflecting a number of previous purchases made by the user from the merchant associated with the initial offer 112, prices paid for the type of goods/services previously purchased, and a location of the associated location-aware user device 140 when the goods/services were previously purchased by the user. It will be appreciated that other user characteristics may also be used by the user characteristics module 208 of the pricing engine 118 to revise the initial price 116.

In another example, the pricing engine 118 may include a location module 210 that is configured to programmatically revise the initial price 116 of the initial offer 112 based on a current location of the user of the location-aware user device 140 as related to the one or more locations of the goods/services associated with the initial offer 112. In one example, the merchant may be a coffee shop and the user device 140 may be associated with a user driving within a predetermined range of the coffee shop, such as ½ mile, or other distance. As the user enters the predetermined range, the user may be more likely to drive to the coffee shop and purchase a coffee drink. Upon determining that the user is within the predetermined range, the location module 210 via the offer agent 102 may revise an initial offer 112 for a coffee drink at an initial price 116 of $3.00 to a revised offer 168 for the coffee drink at a revised price 174 of $2.25.

In another example, the pricing engine 118 may include a quality/decay module 212 that is configured to programmatically revise the initial price 116 of the initial offer 112 based on a quality/decay rate related to a quality of the goods/services that decreases over time. In one example, the merchant may be a greengrocer that has 500 oranges to sell at the greengrocer's fruit stand. The oranges may have an initial freshness that will decrease over a time period, such as 5 days, until the oranges must be discarded. As the quality of the oranges decreases, their market value also decreases. The quality/decay module 212 of the pricing engine 118 may utilize the quality/decay rate of the oranges over the 5 day time period to periodically revise the initial price 116 of the oranges to a lower, revised price 174 as the time period elapses.

In another example, the pricing engine 118 may include a timeframe module 214 that is configured to programmatically revise the initial price 116 of the initial offer 112 based on a timeframe associated with the goods/services. In one example, the merchant may be a hair salon that has open appointment slots on a Saturday between 3-5 pm. On the preceding Friday, the offer agent 102 for the hair salon may generate an initial offer 112 of a haircut during the timeframe of the next day Saturday between 3-5 pm for an initial price 116 of $50. As the timeframe approaches and the appointment slots remain open, the timeframe module 214 of the pricing engine 118 may periodically revise the initial price 116 downward from $50 to progressively lower, revised prices as the timeframe draws near.

In another example, the pricing engine 118 may include a demand module 216 that is configured to programmatically revise the initial price 116 of the initial offer 112 based on a change to a demand rate associated with the goods/services. In one example, the merchant may be the hair salon referenced above with the open appointment slots on Saturday between 3-5 pm. Additionally, there may be several formal events at hotels adjacent to the salon on Saturday evening. From previous experience with formal events at these hotels, the merchant expects increasing demand for haircut services on Saturday afternoon. On the preceding Friday, the offer agent 102 for the hair salon may generate an initial offer 112 of a haircut during the timeframe of the next day Saturday between 3-5 pm for an initial price 116 of $50. As the timeframe approaches and demand for an open slot increases, the demand module 216 of the pricing engine 118 may periodically revise the initial price 116 upward from $50 to progressively higher, revised prices as the timeframe draws near.

In another example, a merchant may anticipate an increase in demand for its goods/service, and may desire to hire one or more additional contractors or employees on short notice to address the increasing demand. In this example, the pricing engine 118 may include and employment module 218 that is configured to programmatically revise the initial price 116 of the initial offer 112 based on the added cost of the additional contractor(s) or employee(s). In one example, the merchant may be the hair salon referenced above with the open appointment slots on Saturday between 3-5 pm, and with the formal events occurring at the hotels adjacent to the salon on Saturday evening. In this example, the hair salon may desire to hire one or more additional hair stylists on a short-term basis to address the expected increased demand leading up to Saturday evening. In addition to the initial offer 112, the offer agent 102 may generate a second offer including a short-term employment opportunity for a hair stylist, and requiring the stylist to begin work on Saturday morning. Upon hiring an additional stylist, the employment module 218 of the pricing engine 118 may revise the initial price 116 of the initial offer 112 upward from $50 to a higher, revised price 174 to account for the added cost of the additional worker. Of course, it will be appreciated that in some circumstances the increased capacity of the merchant to produce goods may lower its cost to produce those goods on a per unit basis, and the employment module 218 may be configured to model this lowered cost. In this case, the pricing engine 118 may be configured to programmatically revise the initial offer 112 downward to a revised price 174 that is lower than the original price as capacity increases and per unit costs decrease. Where there is a demand for more employees computed by the employment module 218, the employment module 218 may be configured to programmatically send notices of increased work hours to current employees, and where current employees are computed not to be able to handle the demand, the employment module 218 may be configured to send notices of employment openings to employment agencies, online employment websites, electronic job bulletin boards, etc.

Pricing engine 118 may further include an ancillary terms module 219 that is configured to programmatically revise ancillary terms of the initial offer based on one or more identified user characteristics of the user associated with the bid agent. For example, the ancillary terms may be warranty terms, shipping terms, service level terms, return policy terms, preferred purchase status terms, affinity reward point terms, item quality terms, or other non-price terms. As one example, a user's transaction history, browsing history and social graph may be monitored by the user client 136 and user characteristics 170 may be inferred that indicate that the user values exclusive offers for expensive goods over deep discounts on inexpensive goods. Based on these inferred user characteristics, the user may be served a revised offer, which includes preferred purchase status terms that give the user preferred access to goods of limited availability, such as a limited edition watch, or a preferred service level such as an upgrade to first class airline seating, etc. In another example, another user may be inferred to have user characteristics 170 that indicate the user responds to reward point offers, and thus the offer may be revised to give double reward points to that user, for example. In yet another example, other users may be detected through transaction histories have user characteristics 170 that indicate they are wary of buying expensive goods without strong warrantees or permissive return policies, and these users may be served revised offers that include such strong warrantees and permissive return policies. Still other users may be detected to be users of a certain shipping mode, such as overnight courier, and shipping terms may be revised to appeal to this user characteristic. As another example, a user may be detected to have a user characteristic 170 of preferring items of a high overall quality, for example, by detecting that when presented with a plurality of different product offerings, the user most often purchases the highest priced item. Accordingly, an item quality term, such as an overall product quality, may be revised in a revised offer. As one example, a user that is detected to prefer high overall quality products may be presented with a revised offer for a pair of diamond earrings that includes diamonds of a higher quality, for example. In this manner, it will be understood that the pricing engine 118 may be used to not only adjust price, but also ancillary terms that are estimated to have particular value to a given user, in an effort to ultimately influence the user's purchase decision.

When an initial offer 112 and/or its initial price 116 is revised by the pricing engine 118 and/or the offer agent 102, a revised offer 168 and/or revised price 174 is created. The revised offer 168 and/or revised price 174 may then be sent to the bid agent 142 for consideration. Upon receiving a revised offer 168 and/or revised price 174, the bid agent 142 may be configured to programmatically modify the initial bid 162 to a revised bid 180 based on one or more of the rules 160 received from its associated user client 136. As noted above, the rules 160 may include, for example, user preferences for particular goods/services, bid pricing guidelines such as bid ceilings, etc. The revised bid 180 is then considered by the offer agent 102. Upon receiving an acceptance from the offer agent 102, the matching engine 146 is configured to process a purchase transaction between the offer agent 102 and the bid agent 142 for the goods/services of the revised offer 168 and corresponding revised bid 180.

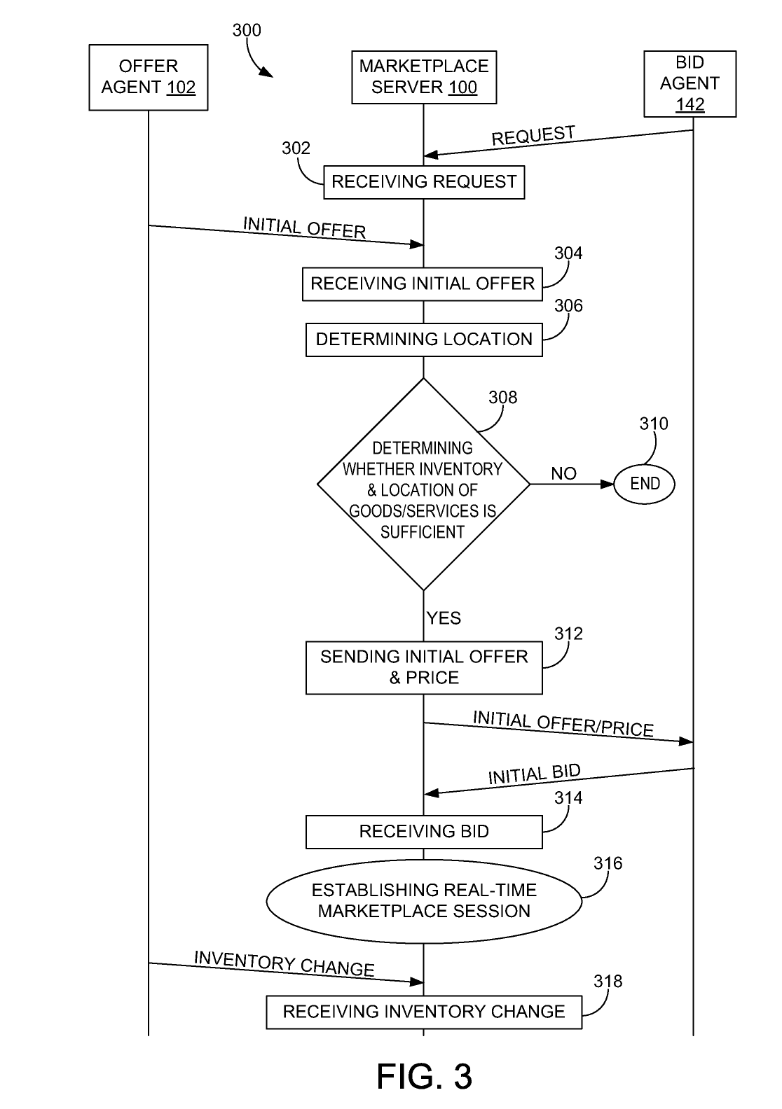

With reference now to FIG. 3, a diagram illustrates a method 300 for dynamic pricing in purchase transactions according to one embodiment of the present disclosure. The method 300 may be performed using the components of the marketplace server 100 described above and shown in FIGS. 1 and 2, or using other suitable components.

The method 300 begins at 302 with receiving a request for goods and/or services from a bid agent, such as bid agent 142, that is associated with a location-aware user device, such as user device 140, and a corresponding user. It will be appreciated that the method 300 may also include receiving additional requests from other bid agents associated with other location-aware user devices. At 304 the method 300 includes receiving an initial offer for goods and/or services from an offer agent, such as offer agent 102, that is associated with a merchant device, such as merchant device 108, and a corresponding merchant.

With reference to an example discussed above, the offer request from the bid agent may be for 4 tickets to a currently sold-out circus performance in downtown Seattle, Wash. The initial offer from the offer agent may be for 4 newly-available tickets to a performance of the circus that begins in 8 hours. At 306 the method 300 includes determining a location of the location-aware user device associated with the bid agent and the corresponding user. In this example, the user associated with the location-aware user device resides in Seattle, Wash. However, the method determines that the user device is currently located in New York City (suggesting that the user is also likely in New York City). At 308 the method 300 includes determining whether an inventory of the tickets and the location of the circus are sufficient to satisfy the user's request, based at least in part on the location of the location-aware user device. In this example, the inventory of 4 tickets is sufficient to satisfy the user's request for 4 tickets. However, given the distant location of the user with respect to the location of the circus performance that begins in 8 hours, the method may determine that this portion of the request cannot be satisfied by the initial offer. In this case, the initial offer is not sent to the bid agent and at 310 the method ends.

In another example, if the location of the location-aware user device is determined to be within a distance of downtown Seattle, Wash. that would enable the user to attend the circus in 8 hours, then at 312 the method 300 includes sending the initial offer along with an initial price to the bid agent. The bid agent 142 may provide the initial offer to the location-aware user device for viewing and consideration by the corresponding user. At 314 the method 300 includes receiving an initial bid from the bid agent.

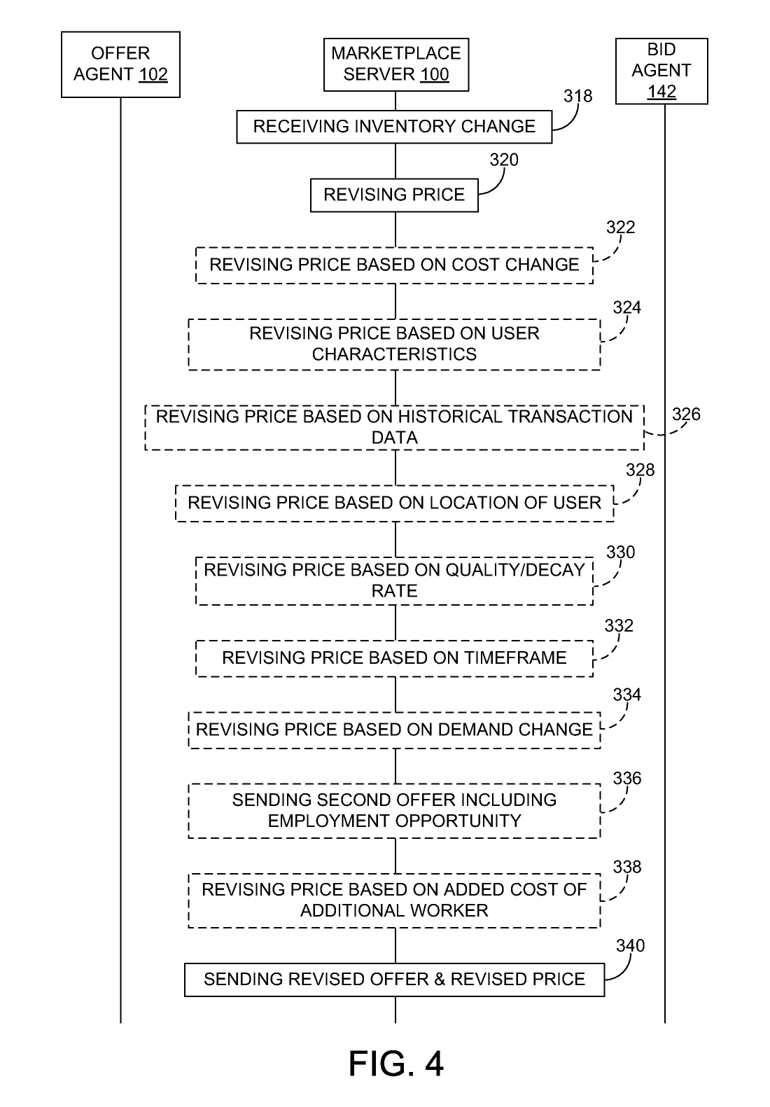

Upon receiving the initial bid, at 316 the method 300 includes establishing a real-time dynamic marketplace session between the offer agent and the bid agent in which a negotiation is facilitated between the merchant associated with offer agent and the user associated with the bid agent. In one example, the offer agent may be associated with a brick and mortar bookstore that has an inventory of 100 copies of Book A. The bookstore may allocate 20 of the 100 copies of Book A to be sold through the marketplace server via the offer agent. The initial offer may include an initial price of $20 for one copy of Book A. As more copies of Book A are purchased via the offer agent, and the allocated inventory of 20 copies decreases, at 318 the method 300 may include receiving changes to the inventory. With reference now to FIG. 4, which is a continuation of the diagram of FIG. 3, at 320 the method 300 may include revising the initial price of the initial offer to a revised price based on the decreasing allocated inventory.

The method 300 may also include revising the initial price based on one or more additional factors. In one example, at 322 the method may include revising the initial price based on a change to a cost of providing the goods/services of the initial offer. As described above, in one example the initial offer may be from a greengrocer for a quantity of oranges. The greengrocer may receive notice that its supplier of oranges is immediately raising prices by 10%. Using this information, the method 300 may calculate a change to the greengrocer's costs of selling the oranges. Using this information, at 322 the method 300 may revise the initial price based on the increasing cost of the oranges.

In another example, at 324 the method may include revising the initial price based on one or more user characteristics of the user associated with the bid agent. As discussed above, the user characteristics may include, for example, a type of the goods/services that were previously purchased by the user, a loyalty measure reflecting a number of previous purchases made by the user from the merchant associated with the initial offer, a price paid for the type of goods/services previously purchased, and a location of the associated location-aware user device when the goods/services were previously purchased by the user. In one example, the initial offer may be from a coffee shop for a discounted coffee drink. The offer agent associated with the coffee shop may determine that the user associated with the bid agent has previously purchased 10 coffee drinks from the coffee shop in the last month. Given this loyalty measure, the method 300 may revise the initial price to a discounted price or may offer the coffee drink for free to this user. It will be appreciated that other user characteristics may also considered and used by the offer agent.

In another example, at 326 the method 300 may include revising the initial price based on historical transaction data related to the goods/services of the initial offer or to similar goods/services. As noted above, the historical transaction data may include data related to previous transactions for the same or similar goods/services. Such data may include, for example, recent prices paid by consumers for the same or similar goods/services. Using this historical transaction data, the method 300 may revise the initial price of the initial offer.

In another example, at 328 the method 300 may include revising the initial price based on a current location of the user of the location-aware user device as related to the one or more locations of the goods/services associated with the initial offer. With reference to an example discussed above, the merchant may be a coffee shop and the user device may be associated with a user driving within a predetermined range of the coffee shop, such as ½ mile. Upon determining that the user is within the predetermined range, the method may include revising the initial offer for a coffee drink at an initial price to a revised offer for the coffee drink at a revised, discounted price.

In another example, at 330 the method 300 may include revising the initial price based on a quality/decay rate related to a quality of the goods/services that decreases over time. As described above, in one example the merchant may be a greengrocer that has 500 oranges to sell at the greengrocer's fruit stand. The oranges may have an initial freshness that will decrease at a quality/decay rate over a time period, such as 5 days, until the oranges must be discarded. As the quality of the oranges decreases, their market value also decreases. Utilizing the quality/decay rate of the oranges over the 5 day time period, the method 300 may include periodically revising the initial price of the oranges to a lower, revised price to stimulate sales.

In another example, at 332 the method 300 may include revising the initial price based on a timeframe associated with the goods/services. In one example discussed above, the merchant may be a hair salon that has open appointment slots on a Saturday between 3-5 pm. On the preceding Friday, the offer agent for the hair salon may generate an initial offer of a haircut during the timeframe of the next day Saturday between 3-5 pm for an initial price. As the timeframe approaches and the appointment slots remain open, the method 300 may include periodically revising the initial price downward to progressively lower, revised prices to stimulate sales.

In another example, at 334 the method 300 may include revising the initial price based on a change to a demand rate associated with the goods/services. As discussed above, in one example the merchant may be the hair salon with the open appointment slots on a Saturday between 3-5 pm. Additionally, there may be several formal events at hotels adjacent to the salon on that Saturday evening. From previous experience with formal events at these hotels, the merchant expects increasing demand for haircut services on Saturday afternoon. On the preceding Friday, the offer agent for the hair salon may generate an initial offer of a haircut on the next day Saturday within a 3-5 pm window for an initial price. As the time window approaches and demand for an open slot increases, the method 300 may include periodically revising the initial price upward to progressively higher, revised prices as the time window draws near.

In another example, the merchant may anticipate an increase in demand for its goods/services, and may desire to hire one or more additional contractors or employees on short notice to address the increasing demand. In one example, the merchant may be the hair salon referenced above with the open appointment slots on Saturday between 3-5 pm, and with the formal events occurring at the hotels adjacent to the salon on Saturday evening. In this example, the hair salon may desire to hire one or more additional hair stylists on a short-term basis to address the expected increased demand leading up to the Saturday evening. In addition to sending the initial offer, at 336 the method 300 may include sending a second offer for a short-term employment opportunity for a hair stylist, and requiring the stylist to begin work on Saturday morning. Upon hiring an additional stylist, at 338 the method may include revising the initial price of the initial offer upward to a higher, revised price to account for the added cost of the additional worker.

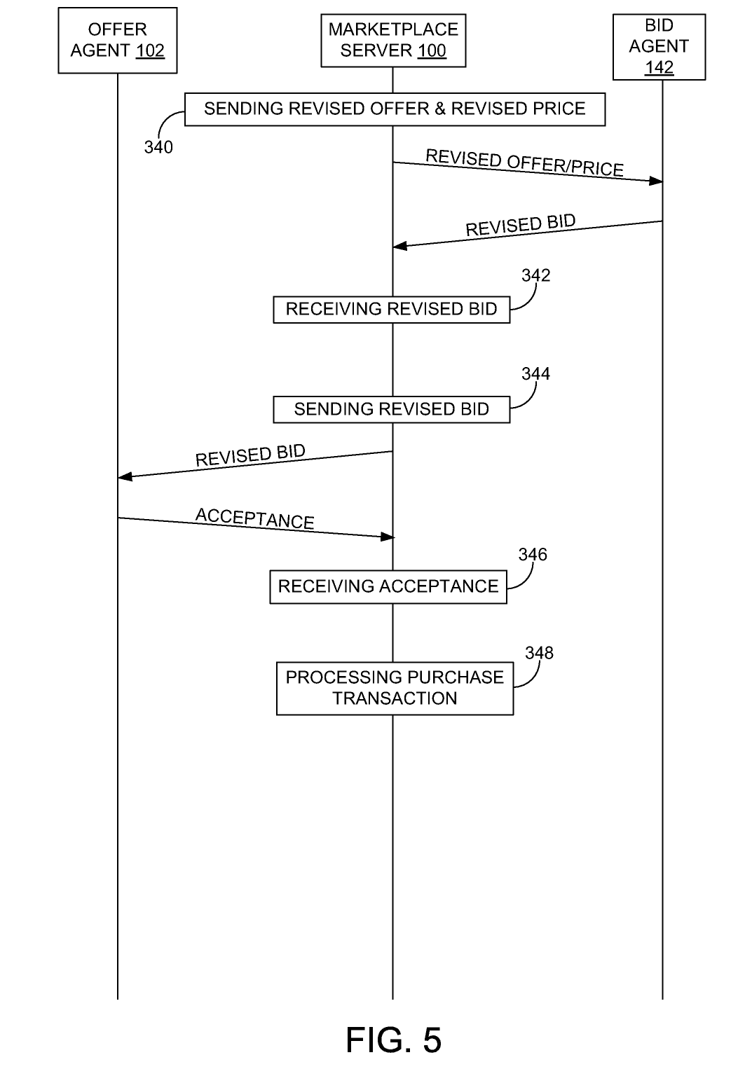

Upon revising the initial offer and/or the initial price, at 340 the method includes sending a revised offer and/or revised price to the bid agent for consideration. With reference now to FIG. 5, which is a continuation of the diagram of FIG. 4, at 342 the method includes receiving a revised bid from the bid agent. At 344 the method includes sending the revised bid to the offer agent for consideration. At 346 the method then includes receiving an acceptance of the revised bid from the offer agent. It will also be appreciated that the negotiation facilitated by the real-time dynamic marketplace session may also include exchanging additional revised offers and/or bids between the offer agent and the bid agent. Upon receiving the acceptance, at 348 the method includes processing a purchase transaction between the offer agent and the bid agent for the goods/services of the revised offer and corresponding revised bid.

The above described systems and methods may be used in an online marketplace to dynamically adjust the price of goods and services based on a detected location of a user's location aware device, thereby addressing the inefficiencies discussed in the Background. As a result, chances may be improved that willing buyers and willing sellers will consummate an agreed upon transaction to the benefit of each party.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A marketplace server, comprising:
a supply engine configured to receive an initial offer for goods/services, the initial offer being based on merchant input including an inventory and one or more locations of the goods/services, the merchant input received at an offer agent located on the marketplace server or on a merchant client executed on a merchant device;
a matching engine configured to:
receive a request from a bid agent associated with a location-aware user device;
determine a location of the location-aware user device;
determine whether the inventory and the one or more locations of the goods/services are sufficient to satisfy the request from the bid agent based at least in part on the location of the location-aware user device;
if the inventory and the one or more locations of the goods/services are sufficient to satisfy the request from the bid agent, then send the initial offer including an initial price to the bid agent;
receive a bid for the initial offer from the bid agent; and
send a revised offer for the goods/services including a revised price to the bid agent;
a pricing engine configured to programmatically revise the initial price of the initial offer to the revised price based on a change to the inventory and/or a change to a cost of providing the goods/services; and
the matching engine further configured to process a purchase transaction between the offer agent and the bid agent for the goods/services.

2. The marketplace server of claim 1, wherein the pricing engine is further configured to programmatically revise the initial price of the initial offer based on a quality/decay rate that is related to a quality of the goods/services that decreases over time.

3. The marketplace server of claim 1, wherein the pricing engine is further configured to programmatically revise the initial price of the initial offer based on a timeframe associated with the goods/services.

4. The marketplace server of claim 1, wherein the pricing engine is further configured to programmatically revise the initial price of the initial offer based on a location of the location-aware user device as related to the one or more locations of the goods/services.

5. The marketplace server of claim 1, wherein the pricing engine is further configured to programmatically revise the initial price of the initial offer based on a change to a demand rate associated with the goods/services.

6. The marketplace server of claim 1,
wherein the change to the inventory of the goods/services is received from the merchant client via a point-of-sale device that tracks the inventory of the goods/services; or
wherein the change to the inventory of the goods/services and the change to the cost of providing the goods/services are received from the offer agent via direct input from a merchant associated with the merchant device.

7. The marketplace server of claim 1, wherein the pricing engine is further configured to programmatically revise the initial price of the initial offer based on historical transaction data for the goods/services or similar goods/services.

8. The marketplace server of claim 1, wherein the pricing engine is further configured to programmatically revise the initial price of the initial offer based on one or more user characteristics of a user associated with the bid agent.

9. The marketplace server of claim 8, wherein the pricing engine is further configured to programmatically revise ancillary terms of the initial offer based on one or more user characteristics of the user associated with the bid agent, the ancillary terms being selected from the group consisting of warranty terms, shipping terms, service level terms, return policy terms, preferred purchase status terms, and affinity reward point terms.

10. The marketplace server of claim 1, wherein the initial offer is a first offer and a second offer includes an employment opportunity related to the goods/services, and the pricing engine is further configured to programmatically revise the initial price of the first offer based on an additional cost of a worker filling the employment opportunity.

11. A method for dynamic pricing in real-time marketplace transactions, the method comprising:
receiving a request from a bid agent associated with a location-aware user device;
receiving an initial offer for goods/services from an offer agent associated with a merchant device, the initial offer including an inventory and one or more locations of the goods/services;
determining a location of the location-aware user device;
determining whether the inventory and the one or more locations of the goods/services are sufficient to satisfy the request based at least in part on the location of the location-aware user device;
if the inventory and the one or more locations of the goods/services are sufficient to satisfy the request from the bid agent, then establishing a real-time dynamic marketplace session between the offer agent and the bid agent;
sending the initial offer including an initial price to the bid agent;
receiving a bid for the initial offer from the bid agent;
revising the initial price of the initial offer to a revised price based on a change to the inventory and/or a change to a cost of providing the goods/services;
sending a revised offer for the goods/services including a revised price to the bid agent;
receiving a revised bid from the bid agent;
sending the revised bid to the offer agent;
receiving an acceptance from the offer agent; and
processing a purchase transaction for the goods/services between the offer agent and the bid agent.

12. The method of claim 11, further comprising receiving the change to the inventory of the goods/services from a merchant client on the merchant device via a point-of-sale device that tracks the inventory of the goods/services.

13. The method of claim 11, further comprising revising the initial price of the initial offer based on a quality/decay rate that is related to a quality of the goods/services that decreases over time.

14. The method of claim 11, further comprising revising the initial price of the initial offer based on a timeframe associated with the goods/services.

15. The method of claim 11, further comprising revising the initial price of the initial offer based on a location of the location-aware user device as related to the one or more locations of the goods/services.

16. The method of claim 11, further comprising revising the initial price of the initial offer based on a change to a demand rate associated with the goods/services.

17. The method of claim 11, further comprising revising the initial price of the initial offer based on historical transaction data for the goods/services or similar goods/services.

18. The method of claim 11, further comprising revising the initial price of the initial offer based on one or more user characteristics of a user associated with the bid agent.

19. The method of claim 11, wherein a second offer includes an employment opportunity related to the goods/services, and further comprising revising the initial price of the initial offer based on an additional cost of a worker filling the employment opportunity.

20. A method for dynamic pricing in real-time marketplace transactions, the method comprising:
receiving a request from a bid agent associated with a location-aware user device;
receiving an initial offer for goods/services from an offer agent associated with a merchant device, the initial offer including an inventory and one or more locations of the goods/services;
determining a location of the location-aware user device;
determining whether the inventory and the one or more locations of the goods/services are sufficient to satisfy the request based at least in part on the location of the location-aware user device;
if the inventory and the one or more locations of the goods/services are sufficient to satisfy the request from the bid agent, then establishing a real-time dynamic marketplace session between the offer agent and the bid agent;
sending the initial offer including an initial price to the bid agent;
receiving a bid for the initial offer from the bid agent;
receiving a change to the inventory of the goods/services from a merchant client on the merchant device via a point-of-sale device that tracks the inventory of the goods/services;
receiving historical transaction data for the goods/services or similar goods/services from a data store;
receiving one or more user characteristics of a user associated with the bid agent;
revising the initial price of the initial offer to a revised price based on the change to the inventory, the historical transaction data, and the one or more user characteristics;
sending a revised offer for the goods/services including a revised price to the bid agent;
receiving a revised bid from the bid agent;
sending the revised bid to the offer agent;
receiving an acceptance from the offer agent; and
processing a purchase transaction for the goods/services between the offer agent and the bid agent.
